(19) United States
(12) Patent Application Publication
(10) Pub. No.: US 2025/0390397 A1
(43) Pub. Date: Dec. 25, 2025

(54) SYSTEMS AND METHODS FOR USE IN ACCOMMODATING EVENT PUBLICATION DELAY IN EVENT-DRIVEN SCHEMES

(71) Applicant: MASTERCARD INTERNATIONAL INCORPORATED, PURCHASE, NY (US)

(72) Inventors: Manuj Arora, Pune (IN); Amresh M D, Chennai (IN); Atul Sharma, Pune (IN); Vignesh Katravath, Hyderabad (IN)

(21) Appl. No.: 19/210,988

(22) Filed: May 16, 2025

Related U.S. Application Data
(60) Provisional application No. 63/663,477, filed on Jun. 24, 2024.

(51) Int. Cl. G06F 11/14

(52) U.S. Cl. CPC G06F 11/1469; G06F 11/1451

(57) ABSTRACT

Systems and methods are provided for accommodating event publication delays in an event-driven architecture. One example computer-implemented method includes, based on a failed publication of an original event to a primary message bus: consuming, by an event recovery facilitator, a backup event from a secondary message bus, based on a first topic of the backup event, the event recovery facilitator being a computing device, the backup event including data from the original event; identifying, by the event recovery facilitator, an original topic of the backup event, the original topic of the event different than the first topic of the backup event; determining, by the event recovery facilitator, that the original topic is active on the primary message bus and based on thereon, publishing the backup event to the original topic on the primary message bus.

### CROSS-REFERENCE TO RELATED APPLICATION

This application claims the benefit of, and priority to, U.S. patent application Ser. No. 63/663,477, filed on Jun. 24, 2024. The entire disclosure of the above application is incorporated herein by reference.

### FIELD

The present disclosure is generally directed to systems and methods for use in accommodating event publication delay in event-driven schemes/architecture.

### BACKGROUND

This section provides background information related to the present disclosure, which is not necessarily prior art.

Data is known to be stored in databases and communicated between different users. A number of different schemes are known to be used to communicate the data. Among the schemes, more recently, event-driven architectures rely on events published on message buses, by producers or publishers, to be consumed by consumers or subscribers, based on topics to which the events are published. The event-driven architectures may be employed in situations in which sequential or parallel processing of data may be required, which may be performed by consumers of data from the message buses, whereby the consumers publish results of the processing back to the message buses.

### DRAWINGS

The drawings described herein are for illustrative purposes only of selected embodiments and not all possible implementations, and are not intended to limit the scope of the present disclosure.

FIG. 1 is an example system of the present disclosure suitable for accommodating event publication delay in an event-driven scheme/architecture;

FIG. 2 is a block diagram of an example computing device that may be used in the example system of FIG. 1; and

FIG. 3 includes a flow diagram for an example method, which may be implemented in connection with the system of FIG. 1, for accommodating event publication delay in an event-driven scheme/architecture.

Corresponding reference numerals indicate corresponding parts throughout the several views of the drawings.

### DETAILED DESCRIPTION

Example embodiments will now be described more fully with reference to the accompanying drawings. The description and specific examples included herein are intended for purposes of illustration only and are not intended to limit the scope of the present disclosure.

Event-driven architectures rely on publishers publishing events and consumers consuming the events published to message buses. From time to time, the publishers have issues publishing events to the message buses, which may be due to transient issues or long-term failures of messages at the message bus. This can lead to substantial impacts in processing tasks, on which the events rely, as single points of failure in processing of the tasks (e.g., payment interactions, etc.) often derails processing in general. As such, for a given task, such as interaction processing, the event-driven schemes define a technical problem in publication delays, for which a technical solution is required.

Uniquely, the systems and methods herein provide for accommodating event publication delay in an event-driven scheme/architecture.

In particular, a secondary message bus and a secondary message broker are defined, whereby a publisher of a failed event publishes the event to the secondary message bus. The secondary message broker, or event recovery facilitator, queues the events from the secondary message bus and publishes the events to the original topic to the primary message bus when the primary message bus is available. In this manner, a technical solution for failed publication is permitted, whereby the original event publishers are permitted to continue in normal operation without queueing the failed event publications. The event recovery facilitator is imposed to queue the events and publish the same, so that consumers of events on the primary message bus do not miss any events directed to the primary message bus, even with transient issues or long-term failures of the primary message bus. In this way, the systems and methods herein aid in achieving zero event loss through alternate message brokers along with transient persistence.

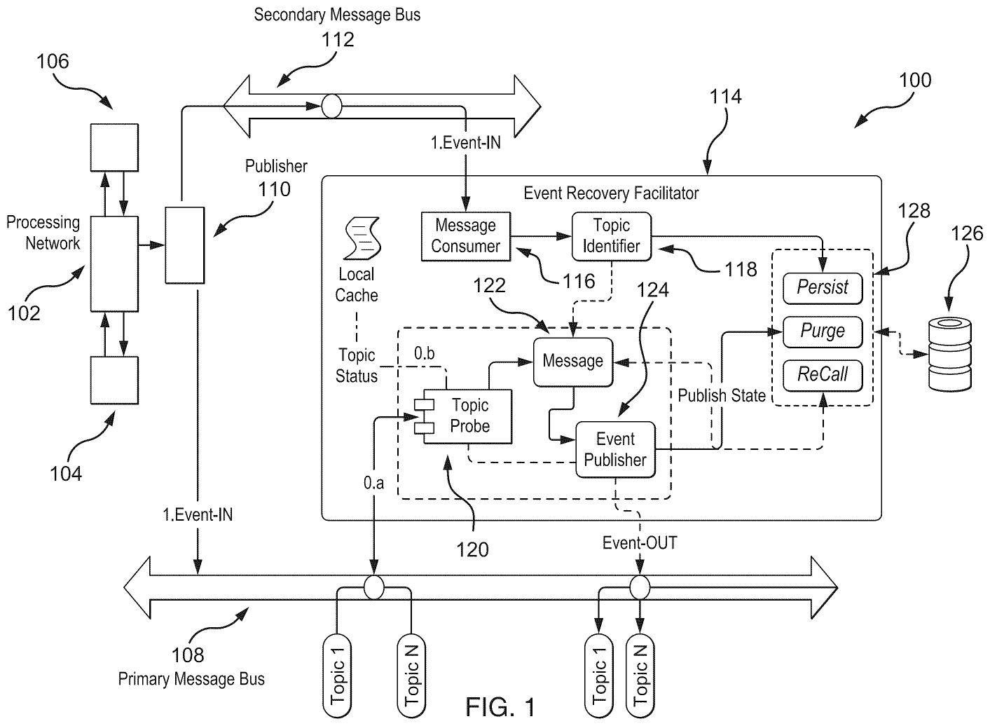

FIG. 1 illustrates an example system 100, in which one or more aspects of the present disclosure may be implemented. Although the system 100 is presented in one arrangement, other embodiments may include the parts of the system 100 (or other parts) arranged otherwise depending on, for example, communication schemes, distribution of data, types and numbers of producers/subscribers, security requirements associated with databases, etc.

The illustrated system 100 includes a processing network 102, which is coupled to an acquirer institution 104 and an issuer institution 106.

In this example embodiment, the acquirer institution 104 is a bank or other financial institution, which is configured to participate in payment transactions, in which funds are transferred from accounts issued by another bank (or banks) into an account issued by the acquirer institution 104. The payment transactions are directed to users to which the accounts are issued (e.g., merchants, persons, etc.). Similarly, the issuer institution 106 is a bank or other financial institution, which is configured to participate in payment transactions, in which funds are transferred from an account(s) issued by the issuer institution 106 into an account(s) issued by another bank (e.g., the acquirer institution 104, etc.). The payment transactions are directed from (or funded by) users to which the accounts are issued (e.g., businesses, persons, etc.).

The processing network 102 is configured to facilitate messaging representative of the payment interactions, such as, for example, authorization, clearing, settlement, etc., messaging., which form, in general, a processing switch for payment account interactions. In connection with processing the payment interactions, the processing network 102 is configured to provide one or more services in connection with the interactions. The services may include, without limitation, loyalty services, fraud monitoring services, audit logging services, message routing services, cryptography services, tokenization services, tokenized transaction services, etc.

It should be appreciated that the processing network 102 may be configured to provide other suitable services in connection with one or more interactions in other embodiments.

In this example embodiment, the processing network 102 is configured consistent with an event-driven architecture, which includes a primary message bus 108 and an event publisher 110 (as shown in FIG. 1). In connection therewith, the event publisher 110 is configured to compile an event and to publish the event to the primary message bus 108 to a particular topic. The events may be related to one or more tasks to be performed, etc. The primary message bus 108, in turn, is configured to receive, from the event publisher 110, and to persist messages to be consumed by consumers along the primary message bus 108, which are subscribed to the topics of the events. The consumers, while not shown, may be configured to consume the events from the primary message bus 108 and to perform, as appropriate, one or more tasks related to the above identified services, etc.

The message bus 108 and the event publisher 110 are configured to operate in the above manner for hundreds of thousands, millions, tens of millions, etc., events over time intervals of hours, etc.

Given the above, in this example embodiment, the processing network 102 is configured to receive a transaction message from the acquirer institution 104 (e.g., an authorization message, etc.), via an edge device (not shown) such as, for example, an interface processor (e.g., a MASTERCARD interface processor (MIP), etc.), etc. The message is provided to the publisher 110. The event publisher 110 is configured to compile an event specific to the message and to publish the event on the primary message bus 108. The event is published to a specific message topic and includes data indicative of the message, and also a message ID and certain metadata specific thereto.

As noted above, from time to time, the publication of the event may fail (e.g., due to transient issues or long-term failures, etc.), whereby the primary message bus 108 is configured to notify the event publisher 110 of the failed publication. The failed publication may be due to any number of failure conditions, including, for example, without limitation, network failures, a leader-node of message bus being unavailable, failures due to upgrade/maintenance, synchronization failures between replication nodes in message bus clusters, etc., which may include, for example, a specific node of the primary message bus 108 indicated as being inoperable, etc. In this way, the failed event publication is generally topic specific, and may further be partition specific within the single topic.

In addition, in this example embodiment, uniquely, as shown in FIG. 1, the processing network 102 includes a secondary message bus 112 and an event recovery facilitator 114 coupled in communication with the primary message bus 108 and the secondary message bus 112.

It should be understood that the primary message bus 108 may be a Kafka-type message bus, and that the secondary message bus 112 may be a NATS-type message bus, or vice-versa. The Kafka-type message bus is a distributed implementation of a message bus that is configured to enable services to publish and read event streams in near real time (e.g., within seconds, less than a second, etc.). In at least one example, the message buses 108, 112 are of the same type, yet separate, different, etc. from one another. The types of message buses (e.g., RabbitMQ, Kafka, NATS, ActiveMQ message buses, etc.) may be with or without durability (persistence), such as, for example, NATS without durability, or Kafka with durability.

In this example embodiment, in response to the failed publication of an event to the primary message bus 108, the event publisher 110 is configured to publish a backup event (specific to the event) to the secondary message bus 112 (e.g., in general, or to one or more specific topics, etc.). The event recovery facilitator 114 is subscribed to one or more topics on the secondary message bus 112, whereby the event recovery facilitator 114 is configured to consume the backup event. The event recovery facilitator 114 is configured to queue the backup event in a data structure, and to publish the backup event to the primary message bus 108, based on the failure condition being resolved (e.g., upon notification, indication, determination, etc., of the failure condition being resolved; etc.).

In particular, in the example embodiment shown in FIG. 1, the event recovery facilitator 114 includes a message consumer 116, a topic identifier 118, a topic probe 120, a message handler 122, an event publisher 124, and a data structure 126.

Based on the above failure of the publisher 110 to publish the event to the primary message bus 108, whereby the backup event is published to the secondary message bus 112, the message consumer 116 is configured to consume backup events (specific to the original event) from the secondary message bus 112, based on a specific topic, for example. The topic may be, for example, Backup_event_1, etc. The message consumer 116 is configured to then pass the backup event to the topic identifier 118. The topic identifier 118, in turn, is configured to identify the topic of the backup event, to notify the message handler 122 of the topic, and then to store the backup event in the data structure 126, via an access module 128. The access module 128 is configured to support persist, purge, and recall operations to/from/with the data structure 126.

It should be appreciated that backup events may accumulate in the data structure 126, over time, as the primary message bus 108 remains unreachable.

The message handler 122 is configured to notify the topic probe 120 of the identified topic, whereby the topic probe 120 is configured to probe, repeatedly, the primary message bus 108 for the topic. That is, the topic probe 120 is configured to generate heartbeat, or repeated, attempts to publish to the primary message bus 108 for the topic (e.g., as a probe event, etc.), and other topics (as shown as Topic 1 through Topic N in FIG. 1, etc.), at one or more regular or irregular intervals. In response, the topic probe 120 is configured to compile a list of topics, and sub-topics, potentially, for the primary message bus 108, which are unreachable. The optic “status” is maintained in a local cache of the topic probe 120.

When the topic becomes available, through a successful publication by the topic probe 120, the topic probe 120 is configured to notify the message handler 122 of the operability of the primary message bus 108 (or topic), to cease publication of the heartbeat (or probe events), i.e., repeated attempts to publish to the specific topic on the primary message bus 108, and to update the local cache with the status.

In response, the message handler 122 is configured to recall the backup event(s) to the topic from the data structure 126, via the access module 128, and to provide the backup events to the event publisher 124. In turn, the event publisher 124 is configured to publish the backup events to the primary message bus 108, to the original topic to be consumed as originally intended, and to purge the successfully published backup events from the data structure 126, via the access module 128.

It should be appreciated, from FIG. 1, that the event recovery facilitator 114 is configured to operate on multiple topics, such as, for example, Topic1, Topic 2, . . . . Topic N, etc., whereby, in general, the event recovery facilitator 114 accommodates delayed publication to the primary message bus 108, while inhibiting missed events due to failed publications.

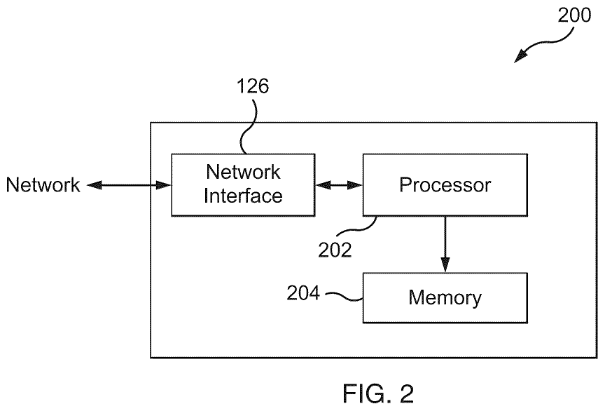

FIG. 2 illustrates an example computing device 200 that can be used in the system 100 of FIG. 1. The computing device 200 may include, for example, one or more servers, workstations, personal computers, laptops, tablets, smartphones, etc. In addition, the computing device 200 may include a single computing device, or it may include multiple computing devices located in close proximity or distributed over a geographic region, so long as the computing devices are specifically configured to function as described herein. In the example embodiment of FIG. 1, the processing network 102, the acquirer institution 104, the issuer institution 106, the primary message bus 108, the event publisher 110, the secondary message bus 112, and the event recovery facilitator 114 (and identified parts thereof) are and/or include one or more computing devices, either together or separately, which include and/or are generally consistent with the computing device 200. However, the system 100 should not be considered to be limited to the computing device 200, as described below, as different computing devices and/or arrangements of computing devices may be used in other embodiments. In addition, different components and/or arrangements of components may be used in other computing devices.

Referring to FIG. 2, the example computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may be configured to store, without limitation, messages, events, status, topics, and/or other types of data (and/or data structures) suitable for use as described herein.

Furthermore, in various embodiments, computer-executable instructions may be stored in the memory 204 for execution by the processor 202 to cause the processor 202 to perform one or more of the functions described herein (e.g., one or more of the operations of method 300, etc.), such that the memory 204 is a physical, tangible, and non-transitory computer readable storage media. Such instructions often improve the efficiencies and/or performance of the processor 202 that is performing one or more of the various operations herein, whereby such performance may transform the computing device 200 into a special purpose computing device. It should be appreciated that the memory 204 may include a variety of different memories, each implemented in one or more of the operations or processes described herein.

The illustrated computing device 200 also includes a network interface 206 coupled to (and in communication with) the processor 202 and the memory 204. The network interface 206 may include, without limitation, a wired network adapter, a wireless network adapter, a mobile network adapter, or other device capable of communicating to one or more different ones of the networks, and/or with other devices described herein. In some example embodiments, the computing device 200 may include the processor 202 and one or more network interfaces incorporated into or with the processor 202.

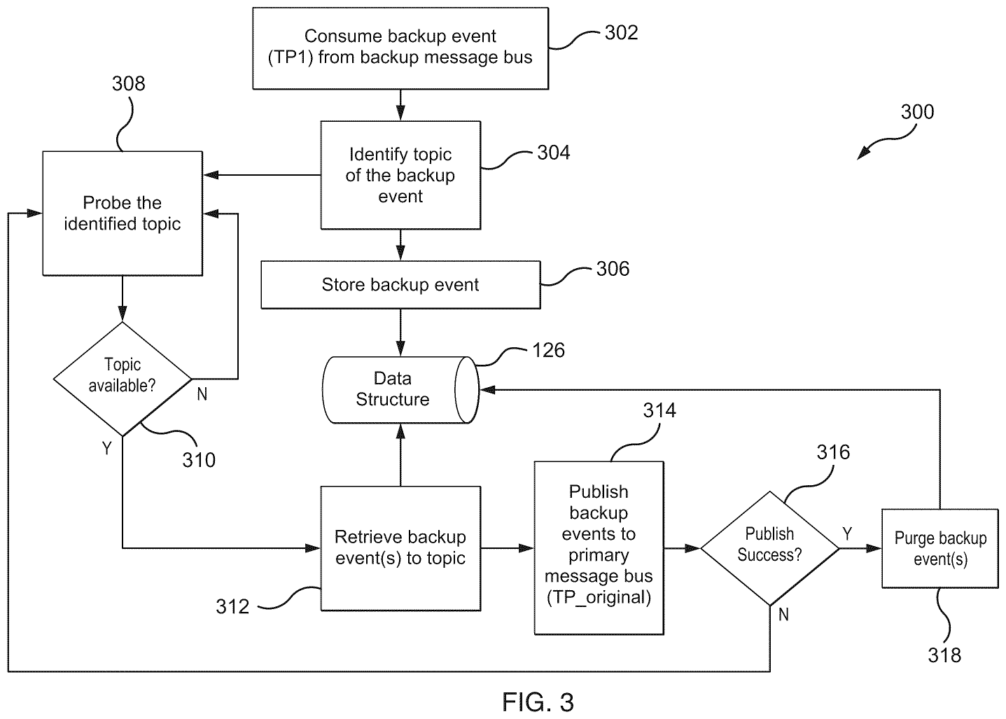

FIG. 3 illustrates an example method 300 for use in accommodating event publication delay in an event-drive scheme/architecture. The example method 300 is described as implemented in the system 100, and in particular, the event recovery facilitator 114 and the associated message buses 108, 112. Reference is also made to the computing device 200. However, the methods herein should not be understood to be limited to the system 100 or the computing device 200, as the methods may be implemented in other systems and/or computing devices. Likewise, the systems and the computing devices herein should not be understood to be limited to the example method 300.

At the outset, in general, the event publisher 110 publishes events to the primary message bus 108, whereby consumers consume the events from the primary message bus 108. Based on the event, one or more services may be implemented through one or more tasks being performed by the consumer. In connection therewith, an event may be delayed to the primary message bus 108, whereupon the primary message bus 108 issues a failed publication notice to the event publisher 110. In response to the failed publication notice, the event publisher 110 publishes the “backup” event (which is consistent with the original event) to the secondary message bus 112, under a topic indicative of the event being a backup event for a failed publication to the primary message bus 108. In this example, the topic (or backup topic) is designated as topic TP1.

The event recovery facilitator 114 (e.g., an event recovery facilitator computing device consistent with computing device 200, etc.), and in particular, the message consumer 116, consumes, at 302, the backup event from the secondary message bus 112, based on being subscribed to backup events, i.e., the specific topic TP1.

The topic of the consumed backup event is then identified, by the topic identifier 118, as the original topic of the event, or in this example, TP_original, at 304, and then, at 306, the backup event is stored in the data structure 126 (e.g., via a persist operation of the access module 128, etc.). The topic probe 120 is also notified on the topic TP_original of the consumed backup event which is specific to the primary message bus 108 (and not the secondary message bus 112).

At 308, the event recovery facilitator 114, and in particular, the topic probe 120, probes the primary message bus 108 by attempting to publish one or more events to the topic TP_original on the primary message bus 108. The attempted publications may be initiated upon consumption of the backup event and continue at one or more regular or irregular intervals thereafter, as appropriate. For each publication, the topic probe 120 determines, at 310, whether the topic TP_original is available on the primary message bus 108 (e.g., as indicated by a successful publication of an event to the primary message bus 108 to that topic, etc.).

When the topic TP_original continues to be unavailable, the topic probe 120 continues to attempt to publish event(s), at the one or more regular or irregular time intervals, to the primary message bus 108, at 308.

Conversely, when the topic TP_original is available (as indicated by the event being successfully published thereto), the event recovery facilitator 114, and in particular, the message handler 122, determines the primary message bus 108 is now reachable and retrieves the backup event(s) for the topic TP_original from the data structure 126 (e.g., via a recall operation of the access module 128, etc.), at 312. The event recovery facilitator 114, and in particular, the event publisher 124, then publishes, at 314, the backup events to the primary message bus 108 to the original topic of the events, i.e., topic TP_original. It should be understood that the backup event is published to the primary message bus 108 as essentially a duplicate of the original event attempted to be published by the publisher 110.

In connection therewith, the event recovery facilitator 114, and in particular, the message handler 122, determines, at 316, whether the backup event was indeed successfully published to the primary message bus 108 (i.e., there is no failed publication notice from the primary message bus 108). When the backup event was successfully published, then, as shown in FIG. 3, the event recovery facilitator 114, and in particular, the event publisher 124, purges the published ones of the backup event(s) from the data structure 126 (e.g., via a purge operation of the access module 128, etc.), at 318, to eliminate the resolved backup events from the data structure 126.

When the backup event was not successfully published to the primary message bus 108, the event recovery facilitator 114 returns backward in method 300 (e.g., to step 308, etc.) without purging the backup event from the data structure 126. In this way, the event recovery facilitator 114 then continues to attempt to publish event(s), at the one or more regular or irregular time intervals, to the primary message bus 108, at 308, while preserving the backup event in the data structure 126 to attempt again to publish the same to the primary message bus 108 when the primary message bus 108 is reachable.

It should be understood that the method 300 may be executed in parallel for multiple different events, failed publication notifications, etc., in the event recovery facilitator 114, as necessary as different topics become unavailable at the primary message bus 108.

In view of the above, the systems and methods herein are enabled to accommodate event publication delay in an event-driven scheme/architecture.

Missed events in various schemes/architectures may provide substantial impacts in processing as single points of failure for that unique processing. By accommodating event publication delay (e.g., due to failure conditions, etc.) (e.g., from millisecond transients to longer term failures, etc.), via an alternate broker (e.g., event recovery facilitator, etc.) available as a secondary route with transient persistence, the systems and methods herein inhibit event loss and impact to the processing operations. In this way, a technical solution is provided to queue failed publications and to republish the same so that consumers on the primary message bus, thereby avoiding missing events directed to the primary message bus, even with transient or long-term failures of the primary message bus.

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by, based on a failed publication of an original event to a primary message bus: (a) consuming, by an event recovery facilitator, a backup event from a secondary message bus, based on a first topic of the backup event, the event recovery facilitator being a computing device, the backup event including data from the original event; (b) identifying, by the event recovery facilitator, an original topic of the backup event, the original topic of the event different than the first topic of the backup event; (c) determining, by the event recovery facilitator, that the original topic is active on the primary message bus; and/or (d) in response to determining that the original topic is active on the primary message bus, publishing the backup event to the original topic on the primary message bus.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” and the phrase “at least one of”' includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

The foregoing description of example embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in accommodating event publication delay in an event-driven architectures, the method comprising:
based on a failed publication of an original event to a primary message bus:
consuming, by an event recovery facilitator, a backup event from a secondary message bus, based on a first topic of the backup event, the event recovery facilitator being a computing device, the backup event including data from the original event;
identifying, by the event recovery facilitator, an original topic of the backup event, the original topic of the event different than the first topic of the backup event;
determining, by the event recovery facilitator, that the original topic is active on the primary message bus; and
in response to determining that the original topic is active on the primary message bus, publishing the backup event to the original topic on the primary message bus.

2. The computer-implemented method of claim 1, further comprising storing, by the event recovery facilitator, the backup event in a data structure, after consuming the backup event, and prior to determining that the original topic is active on the primary message bus.

3. The computer-implemented method of claim 1, wherein determining that the original topic is active on the primary message bus includes probing the primary message bus for the original topic.

4. The computer-implemented method of claim 3, wherein probing the primary message bus for the original topic includes:
publishing, by the event recovery facilitator, a probe event to the original topic on the primary message bus; and
determining that the original topic is active on the primary message bus based on a successful publishing of the probe event.

5. The computer-implemented method of claim 4, wherein publishing the probe event includes publishing multiple probe events to the primary message bus at a regular interval; and
wherein determining that the original topic is active on the primary message bus is based on a successful publishing one of the multiple probe events.

6. The computer-implemented method of claim 1, further comprising purging the backup event from a data structure upon successfully publishing of the backup event to the original topic on the primary message bus.

7. The computer-implemented method of claim 1, further comprising publishing, by an event publisher, the backup event to the secondary message bus, in response to a failed publication of said original event to the primary message bus.

8. The computer-implemented method of claim 1, wherein the backup event directs a task, by a processing network, related to an account transaction.

9. A system for use in accommodating event publication delay in an event-driven architectures, the system comprising:
an event recovery facilitator computing device, which is configured, by executable instructions, to:
based on a failed publication of an original event to a primary message bus:
consume a backup event from a secondary message bus, based on a first topic of the backup event, the event recovery facilitator being a computing device, the backup event including data from the original event;
identify an original topic of the backup event, the original topic of the event different than the first topic of the backup event;
determine that the original topic is active on the primary message bus; and
based on determining that the original topic is active on the primary message bus, publish the backup event to the original topic on the primary message bus.

10. The system of claim 9, wherein the event recovery facilitator computing device is configured, by executable instructions, to store, the backup event in a data structure, after consuming the backup event, and prior to determining that the original topic is active on the primary message bus.

11. The system of claim 9, wherein the event recovery facilitator computing device is configured, by executable instructions, in determining that the original topic is active on the primary message bus, to probe the primary message bus for the original topic.

12. The system of claim 11, wherein the event recovery facilitator computing device is configured, by executable instructions, in probing the primary message bus for the original topic, to:
publish a probe event to the original topic on the primary message bus; and
determine that the original topic is active on the primary message bus based on a successful publishing of the probe event.

13. The system of claim 12, wherein the event recovery facilitator computing device is configured, by executable instructions, in publishing the probe event, to publish multiple probe events to the primary message bus at a regular interval.

14. The system of claim 9, wherein the event recovery facilitator computing device is configured, by executable instructions, to purge the backup event from a data structure upon successfully publishing of the backup event to the original topic on the primary message bus.

15. The system of claim 9, further comprising an event publisher, which is configured by second executable instructions, to:
receive a failed publication notification from the primary message bus for the original event; and
in response to the failed publication notification, publish the backup event to the secondary message bus.

16. A non-transitory computer-readable storage medium comprising executable instructions, which when executed by at least one processor, cause the at least one processor to:
based on a failed publication of an original event to a primary message bus:
consume a backup event from a secondary message bus, based on a first topic of the backup event, the event recovery facilitator being a computing device, the backup event including data from the original event;
identify an original topic of the backup event, the original topic of the event different than the first topic of the backup event;
determine that the original topic is active on the primary message bus; and
based on determining that the original topic is active on the primary message bus, publish the backup event to the original topic on the primary message bus.

17. The non-transitory computer-readable storage medium of claim 16, wherein the executable instructions, when executed by the at least one processor, cause the at least one processor to:
store the backup event in a data structure, after consuming the backup event, and prior to determining that the original topic is active on the primary message bus.

18. The non-transitory computer-readable storage medium of claim 16, wherein the executable instructions, when executed by the at least one processor, cause the at least one processor, to:
at one or more intervals, publish a probe event to the original topic on the primary message bus; and
determine that the original topic is active on the primary message bus based on a successful publishing of the probe event.

19. The non-transitory computer-readable storage medium of claim 18, wherein the executable instructions, when executed by the at least one processor, cause the at least one processor, to:
purge the backup event from a data structure upon successfully publishing of the backup event to the original topic on the primary message bus.
